(19) United States
(12) Patent Application Publication
(10) Pub. No.: US 2026/0225562 A1
(43) Pub. Date: Aug. 6, 2026

(54) Spider Axle Repair Kit

(71) Applicant: Crystal Rives, Cleburne, TX (US)

(72) Inventor: Crystal Rives, Cleburne, TX (US)

(21) Appl. No.: 19/450,246

(22) Filed: Jan. 15, 2026

Related U.S. Application Data
(60) Provisional application No. 63/753,045, filed on Feb. 3, 2025.

(51) Int. Cl. B60S 5/00

(52) U.S. Cl. CPC B60S 5/00

(57) ABSTRACT

A spider axle repair kit is provided. The device is comprised of at least one cylindrical tubular sleeve configured for insertion into a reamed bore of a worn spider axle. The sleeve is fabricated from high-strength structural steel alloys selected for their fatigue resistance and weldability, and may undergo various thermal treatments such as case hardening or induction hardening. In certain embodiments, the sleeve is formed in a split configuration of two semi-cylindrical halves joined using fasteners such as hex bolts or quick-lock clamps, followed by tack welding at designated weld areas. Optional surface treatments may include internal composite coatings to minimize axial friction and external corrosion-resistant finishes tailored for road environments. The installation process involves reaming the axle bore, inserting or assembling the sleeve, aligning using optional features, and tack welding in place using methods such as MIG, TIG, or stick welding, with parameters adjusted for material compatibility.

### CROSS-REFERENCE TO RELATED APPLICATION

The present application claims priority to, and the benefit of, U.S. Provisional Application No. 63/753,045, which was filed on February 3, 2025, and is incorporated herein by reference in its entirety.

### FIELD OF THE INVENTION

The present invention relates generally to the field of vehicle axle repair. More specifically, the present invention relates to a kit comprised of at least one cylindrical tubular sleeve configured for insertion into a reamed bore of a worn spider axle of a vehicle. Accordingly, the present disclosure makes specific reference thereto. Nonetheless, it is to be appreciated that aspects of the present invention are also equally applicable to other like applications, devices, and methods of manufacture.

### BACKGROUND

Commercial vehicles, particularly tractor-trailers, rely heavily on the proper functioning of their braking systems to ensure safe operation. A critical component within this system is the spider axle, which is subject to wear over time due to sustained mechanical stress and environmental exposure. When these axles deteriorate, braking performance can be significantly compromised, increasing the risk of accidents and mechanical failure. Repairs typically require the complete replacement of the axle, a process that can be labor-intensive, time-consuming, and costly. Specialized services, such as those provided by axle surgeons, are often necessary to carry out these repairs. However, such services may involve long wait times and elevated costs, rendering them impractical for drivers and fleet operators with time-sensitive delivery obligations. Furthermore, individual drivers and small-scale operators may lack the technical skills or equipment required to carry out axle replacement independently. As a result, there is a need for a more accessible, cost-effective, and time-efficient solution that enables vehicle operators to restore axle function without the delays associated with conventional repair services.

Therefore, there exists a long-felt need in the art for a spider axle repair kit that enables vehicle operators to restore axle performance on-site without requiring complete axle replacement. There also exists a long-felt need in the art for a spider axle repair kit that reduces repair time and associated vehicle downtime for commercial fleets. Moreover, there exists a long-felt need in the art for a spider axle repair kit that provides a cost-effective alternative to hiring specialized axle repair professionals.

The subject matter disclosed and claimed herein, in one embodiment thereof, comprises a spider axle repair kit. The device is comprised of at least one cylindrical tubular sleeve configured for insertion into a reamed bore of a worn spider axle. The sleeve is fabricated from high-strength structural steel alloys selected for their fatigue resistance and weldability, and may undergo various thermal treatments such as case hardening or induction hardening. In certain embodiments, the sleeve is formed in a split configuration of two semi-cylindrical halves joined using fasteners such as hex bolts or quick-lock clamps, followed by tack welding at designated weld areas. Optional surface treatments may include internal composite coatings to minimize axial friction and external corrosion-resistant finishes tailored for road environments. The kit may comprise multiple interchangeable sleeves of varying sizes, each identified by color coding or etched indicia. The installation process involves reaming the axle bore, inserting or assembling the sleeve, aligning it using optional features, and tack welding it in place using methods such as MIG, TIG, or stick welding, with parameters adjusted for material compatibility.

In this manner, the spider axle repair kit of the present invention accomplishes all the foregoing objectives and provides a practical means for restoring spider axle functionality on-site without the need for full axle replacement. The design enables rapid installation and reusability of commercial vehicles, thereby minimizing operational downtime. Through the inclusion of high-strength materials, alignment features, and optional coatings, the invention addresses both mechanical performance and environmental durability requirements. The modularity and ease of installation further support independent use by vehicle operators or maintenance personnel, thereby eliminating reliance on costly specialist services. As a result, the invention offers a comprehensive and scalable solution to the persistent challenges associated with spider axle wear in commercial transportation fleets.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a spider axle repair kit. The spider axle repair kit is comprised of components designed to restore axle performance by enabling on-site repairs, thereby reducing downtime and eliminating the need for complete axle replacement.

The spider axle repair kit is comprised of at least one cylindrical tubular sleeve configured for press-fitting or internal seating within a reamed bore of a worn spider axle. In one embodiment, the interior wall of the sleeve comprises structural geometries including concentric ridges, helical grooves, or diamond-pattern knurling to improve mechanical engagement prior to welding.

A leading edge of the sleeve may be beveled, radiused, or chamfered to facilitate installation, with tapers up to 45 degrees available for alignment. The sleeve may further include external alignment features such as circumferential detents or notches that engage with axle body guides to ensure proper angular orientation.

In one embodiment, the sleeve may also be provided in a split configuration comprising two semi-cylindrical halves, joined using at least one fastener selected based on the torque and vibration profile of the application. After fastening, the halves may be permanently secured via tack welding. Each sleeve half includes designated areas such as weld holes or slots to support weld penetration.

To accommodate a range of axle configurations, the kit may include multiple interchangeable sleeves of varying diameters and lengths. These sleeves may be color-coded or marked with laser-etched indicia for identification.

The method of using the spider axle repair kit includes providing a sleeve with defined internal geometries, edge features, and optional coatings, preparing the axle bore by cleaning and reaming, inserting and aligning the sleeve, joining split sleeve halves if applicable, and tack welding the installed sleeve using an appropriate welding method and parameters.

Accordingly, the spider axle repair kit of the present invention is particularly advantageous as it provides a practical means for restoring spider axle functionality on-site without the need for full axle replacement. The design enables rapid installation and reusability of commercial vehicles, thereby minimizing operational downtime. Through the inclusion of high-strength materials, alignment features, and optional coatings, the invention addresses both mechanical performance and environmental durability requirements. The modularity and ease of installation further support independent use by vehicle operators or maintenance personnel, thereby eliminating reliance on costly specialist services. As a result, the invention offers a comprehensive and scalable solution to the persistent challenges associated with spider axle wear in commercial transportation fleets.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a spider axle repair kit of the present invention in accordance with the disclosed architecture;

FIG. 2 illustrates a top view of one potential embodiment of a spider axle repair kit of the present invention with two attached halves in accordance with the disclosed architecture; and

FIG. 3 illustrates a flowchart of a method of using one potential embodiment of a spider axle repair kit of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a spider axle repair kit that enables vehicle operators to restore axle performance on-site without requiring complete axle replacement. There also exists a long-felt need in the art for a spider axle repair kit that reduces repair time and associated vehicle downtime for commercial fleets. Moreover, there exists a long-felt need in the art for a spider axle repair kit that provides a cost-effective alternative to hiring specialized axle repair professionals.

The present invention, in one exemplary embodiment, is comprised of a spider axle repair kit. The spider axle repair kit includes components intended to restore axle performance by facilitating on-site repairs, which in turn reduces vehicle downtime and eliminates the necessity for complete axle replacement. The kit includes at least one cylindrical tubular sleeve configured for press-fitting or internal seating into a reamed bore of a worn spider axle. In one embodiment, the interior wall of the sleeve includes structural geometries such as concentric ridges, helical grooves, or diamond-pattern knurling to enhance mechanical engagement prior to welding.

A leading edge of the sleeve may be chamfered, radiused, or beveled to assist with installation, with alignment tapers of up to 45 degrees available. The sleeve may also include external alignment features such as circumferential detents or notches that engage with axle body guides for proper angular orientation.

In one configuration, the sleeve may be provided as a split assembly formed from two semi-cylindrical halves, joined using at least one fastener selected according to the torque and vibration characteristics of the application. Once joined, the sleeve halves may be permanently fixed in place by tack welding. Each half comprises designated features such as weld holes or slots to facilitate effective weld penetration.

To support compatibility with various axle sizes, the repair kit may include multiple interchangeable sleeves of different diameters and lengths. These sleeves may feature color-coding or laser-etched indicia to aid in identification.

A method of using the spider axle repair kit involves providing a sleeve with defined internal geometries, edge features, and optional coatings, preparing the worn axle bore through cleaning and reaming, aligning and inserting the sleeve, mechanically joining the sleeve halves if in split form, and performing tack welding using a suitable method and welding parameters.

Therefore, the spider axle repair kit provides a practical solution for restoring spider axle function on-site, eliminating the requirement for full axle replacement. The design allows for rapid installation and reusability in commercial vehicles, significantly reducing operational downtime. The integration of high-strength materials, alignment features, and optional coatings addresses both performance and durability. The modular design and straightforward installation process also enable use by vehicle operators or maintenance personnel without the need for specialist intervention. As a result, the invention presents a scalable and cost-effective response to spider axle degradation in commercial fleet applications.

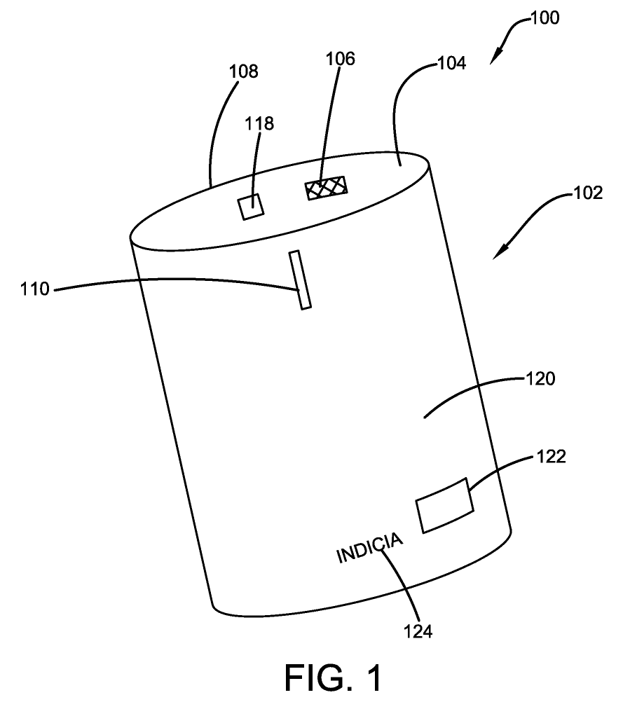

Referring initially to the drawings, FIG. 1 illustrates a perspective view of one potential embodiment of a spider axle repair kit 100 of the present invention in accordance with the disclosed architecture. The present invention is comprised of a spider axle repair kit 100 that can be used to restore axle performance. The kit 100 enables vehicle operators or maintenance personnel to conduct repairs on-site, minimizing vehicle downtime and avoiding complete axle replacement.

The kit 100 is comprised of at least one cylindrical tubular sleeve 102. During use, the sleeve 102 may be externally press-fitted or internally seated into a reamed bore of a worn spider axle. The sleeve 102 may be manufactured using high-strength structural steel alloys such as, but not limited to, chromium-molybdenum steel, boron steel, or nickel-chromium alloy. In some variations, the steel may undergo case hardening, induction hardening, or quenching and tempering to improve fatigue life and welding performance. The interior wall 104 of the sleeve 102 may feature integrated structural geometries 106 such as concentric ridges, shallow helical grooves, or diamond-pattern knurling, (as seen in FIG. 1), which may enhance frictional engagement and mechanical interlock before welding. These internal geometries 106 may be cold-formed or machined based on sleeve thickness and intended axle specifications.

A leading edge 108 of the sleeve 102 may be beveled, radiused, or chamfered to various degrees depending on the specific axle configuration. A full lead-in taper of up to 45 degrees may be applied to assist in precise alignment, while partial bevels may be used for sleeves installed in constrained environments. In some embodiments, the sleeve 102 may incorporate external alignment features 110, such as circumferential detents or indexed notches, which may align with guides or protrusions on the axle body to ensure proper angular orientation.

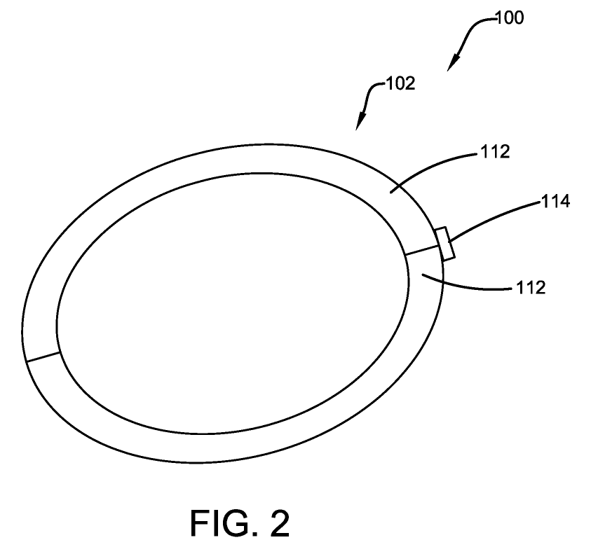

For difficult installations, the sleeve 102 may be available in a split configuration formed by two semi-cylindrical halves 112 that may be joined together using at least one fastener 114 (as seen in FIG. 2) such as, but not limited to, high-strength hex bolts, shoulder bolts, quick-lock clamps, etc., depending on the specific torque and vibration profile of the vehicle. After mechanical joining, the sleeve halves 112 may be secured together permanently via tack welding. In one embodiment, each half 112 is comprised of a dedicated area 116 such as, but not limited to, weld holes, slots, or arc-start recesses, designed to optimize weld penetration without affecting the sleeve 102.

A ceramic and/or metallic composite coating 118 may optionally be applied to the interior wall 104 of the sleeve, as seen in FIG. 1. These coatings 118 may include, but are not limited to, thermally sprayed alumina-titania blends, PVD-applied hard chrome, or nanoceramic resins, all of which may be selected to reduce axial friction and prevent micro-weld adhesion between the axle and the sleeve over time. The external surface of the sleeve 120 may be finished with coatings 122 resistant to corrosion and wear, such as, but not limited to, epoxy primer, powder coating, or electroplated zinc-nickel alloy with passivation. The choice of finish may vary based on expected exposure to road salt, moisture, petrochemicals, or abrasive debris.

To ensure broad compatibility, the repair kit 100 may be provided with multiple interchangeable sleeves 102 of varying diameters and lengths. In one embodiment, the sleeves 102 are color-coded by size (wherein each size is a differing color) and/or comprised of laser-etched indicia 124 for easy identification.

The installation process may begin by removing debris and corrosion from the worn spider axle section, followed by precise reaming of the damaged area to a predetermined depth and diameter. The sleeve may then be inserted manually or using a press tool, depending on the interference fit and tolerances. For split sleeves, mechanical clamping and bolting may precede welding. The tack welds may be applied at structurally isolated locations using a MIG, TIG, or stick welding process, with weld current and duration adjusted to the sleeve material and thickness.

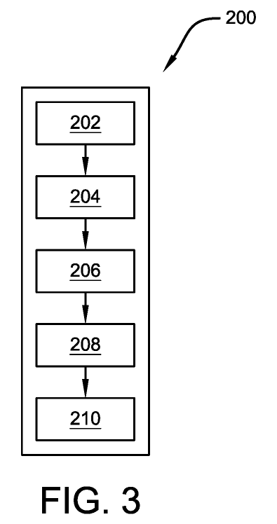

The present invention is also comprised of a method of using 200 the spider axle repair kit 100, as seen in FIG. 3. First, a spider axle repair kit 100 is provided comprised of at least one cylindrical tubular sleeve 102, wherein the sleeve 102 may include an interior wall 104 with integrated structural geometries 106, a leading edge 108 with an alignment taper or bevel, and optionally external alignment features 110 and/or surface coatings 118, 122 [Step 202]. Then, debris and corrosion are removed from the worn spider axle section, and the axle bore is reamed to a predetermined diameter and depth to prepare for sleeve installation [Step 204]. Next, the sleeve 102 is aligned with the reamed axle bore and inserted either manually or using a press tool, wherein the external alignment features 110 may engage with corresponding axle guides for proper angular positioning [Step 206]. Then, in an embodiment where the sleeves 102 provided in a split configuration comprised of two semi-cylindrical halves 112, the halves 112 are positioned around the reamed axle bore and joined using at least one fastener 114, wherein the joined halves 112 form a cylindrical body 102 [Step 208]. Next, the installed sleeve 102 is tack welded directly to the axle at structurally isolated locations using an appropriate welding method selected from MIG, TIG, or stick welding, with weld parameters matched to the sleeve material [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “spider axle repair kit” and “kit” are interchangeable and refer to the spider axle repair kit 100 of the present invention.

Notwithstanding the foregoing, the spider axle repair kit 100 of the present invention and its various components can be of any suitable size and configuration as is known in the art without affecting the overall concept of the invention, provided that they accomplish the above-stated objectives. One of ordinary skill in the art will appreciate that the size, configuration, and material of the spider axle repair kit 100 as shown in the FIGS. are for illustrative purposes only, and that many other sizes and shapes of the spider axle repair kit 100 are well within the scope of the present disclosure. Although the dimensions of the spider axle repair kit 100 are important design parameters for user convenience, the spider axle repair kit 100 may be of any size, shape, and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A spider axle repair kit comprising:
a cylindrical tubular sleeve comprising a leading edge with an alignment taper or a bevel; and
wherein the cylindrical tubular sleeve is comprised of a coating.

2. The spider axle repair kit of claim 1, wherein the cylindrical tubular sleeve is comprised of an interior wall comprised of a concentric ridge, a helical groove, or a diamond-pattern knurling.

3. The spider axle repair kit of claim 1, wherein the coating is comprised of a ceramic coating.

4. The spider axle repair kit of claim 1, wherein the coating is comprised of a metallic composite coating.

5. The spider axle repair kit of claim 1, wherein the coating is comprised of a corrosion-resistant coating.

6. The spider axle repair kit of claim 1, wherein the cylindrical tubular sleeve is comprised of a laser-etched indicia.

7. The spider axle repair kit of claim 1, wherein the cylindrical tubular sleeve is comprised of a circumferential detent.

8. The spider axle repair kit of claim 1, wherein the cylindrical tubular sleeve is comprised of an indexed notch.

9. A spider axle repair kit comprising:
a cylindrical tubular sleeve comprising a first semi-cylindrical half, a second semi-cylindrical half joinable to the first semi-cylindrical half via a fastener, a leading edge with an alignment taper or a bevel; and
wherein the cylindrical tubular sleeve is comprised of a coating.

10. The spider axle repair kit of claim 9, wherein the cylindrical tubular sleeve is comprised of an interior wall comprised of a concentric ridge, a helical groove, or a diamond-pattern knurling.

11. The spider axle repair kit of claim 9, wherein the coating is comprised of a ceramic coating.

12. The spider axle repair kit of claim 9, wherein the coating is comprised of a metallic composite coating.

13. The spider axle repair kit of claim 9, wherein the coating is comprised of a corrosion-resistant coating.

14. The spider axle repair kit of claim 9, wherein the cylindrical tubular sleeve is comprised of a laser-etched indicia.

15. The spider axle repair kit of claim 9, wherein the fastener is comprised of a hex bolt, a shoulder bolt, or a quick-lock clamp.

16. The spider axle repair kit of claim 9, wherein the cylindrical tubular sleeve is comprised of a circumferential detent.

17. The spider axle repair kit of claim 9, wherein the cylindrical tubular sleeve is comprised of an indexed notch.

18. A method of using a spider axle repair kit, the method comprising the following steps:
providing a spider axle repair kit comprised of a cylindrical tubular sleeve;
removing a debris and a corrosion from a spider axle section;
aligning and inserting the cylindrical tubular sleeve into an axle bore of the spider axle section either manually or using a press tool; and
tack-welding the installed cylindrical tubular sleeve to the axle at a structurally isolated location to the spider axle section.

19. The method of using a spider axle repair kit of claim 18, wherein the cylindrical tubular sleeve is comprised of a first half and a second half.

20. The method of using a spider axle repair kit of claim 19, further comprised of attaching the first half to the second half.
